(19) United States
(12) Patent Application Publication
(10) Pub. No.: US 2024/0331330 A1
(43) Pub. Date: Oct. 3, 2024

(54) System and Method for Dynamically Improving the Performance of Real-Time Rendering Systems via an Optimized Data Set

(71) Applicant: Didimo, Inc., Leça da Palmeira (PT)

(72) Inventors: Sean Trevor Cooper, Wellington (GB); Hugo Miguel dos Reis Pereira, Moreira da Maia (PT); André Ministro Tavares, Vila Nova de Gaia (PT); Alexis Paul Benoit Roche, Porto (PT); Rui de Figueiredo Assunção, Paços de Brandão (PT); Adriano Filipe Pinheiro Teixeira, Vila Nova de Gaia (PT); Xenxo Gutier Alvarez Blanco, La Coruña (ES); João Manuel de Vila Fernandes Orvalho, Matosinhos (PT); Verónica Costa Teixeira Pinto Orvalho, Matosinhos (PT); Pedro Miguel de Aguiar Coelho, Lisbon (PT); Pedro Miguel Pereira Ferreirinha, Matosinhos (PT)

(21) Appl. No.: 18/620,851

(22) Filed: Mar. 28, 2024

Related U.S. Application Data
(60) Provisional application No. 63/456,075, filed on Mar. 31, 2023.

(51) Int. Cl. G06T 19/20; G06T 13/40; G06T 15/04

(52) U.S. Cl. CPC G06T 19/20; G06T 13/40; G06T 15/04

(57) ABSTRACT

A system and method for improving the performance of real-time rendering systems via the creation and rendering of s based on an optimized data set. An example method comprises receiving from a user, a first input comprising at least one template character comprising a template character shape model and a template character texture model; optionally, receiving from the user, at least one attachable associated with the at least one template character; receiving from the user, a third input from the user, the third input being in the form of at least one base character model comprising a base character shape model and a base character texture model; and generating, by at least one processor, the optimized data set comprising: optionally, fitting the at least one attachable associated with the at least one template character to the at least one base character model; converting the at least one base character shape model and the at least one base character texture model to an optimized data set; and generating runtime variations on the optimized data set.

### CROSS-REFERENCE TO RELATED APPLICATIONS

The present application claims the priority benefit of U.S. Provisional Patent Application No. 63/456,075, filed Mar. 31, 2023, and is related to U.S. Nonprovisional patent application Ser. No. 15/905,667, filed Feb. 26, 2018, and U.S. Nonprovisional patent application Ser. No. 16/289,363, filed Sep. 12, 2019, which applications are incorporated by reference in their entirety herein.

### FIELD OF TECHNOLOGY

Exemplary systems and methods relate generally to data optimization. In particular, but not by way of limitation, exemplary embodiments provide systems, methods, devices and media for data optimization and character creation and presentation in different scenarios.

### BACKGROUND

The approaches described in this section could be pursued, but are not necessarily approaches previously conceived or pursued. Therefore, unless otherwise indicated, it should not be assumed that any of the approaches described in this section qualify as prior art merely by virtue of their inclusion in this section.

The use of virtual objects and simulated 3D environments has been on the rise across various domains, driven by advancements in technology and their potential to enhance experiences and streamline processes. This trend has been most noticeable in areas as diverse as entertainment and gaming, education and training, architecture and design, manufacturing and engineering, healthcare and retail and marketing.

In the entertainment and gaming domain, there has been a trend towards an increased use of characters in simulated 3D environments driven by advancements in technology and the growing demand for immersive digital experiences. Characters, which are virtual representations of users, play a crucial role in enhancing interactions and personalizing experiences within these environments. Characters have long been a staple of the gaming environment where they serve as the player's in-game representation. As games become more immersive and multiplayer experiences grow in popularity, characters play an increasingly vital role in facilitating social interaction, teamwork, and competition within virtual environments. Players can customize their characters to reflect their preferences and identities, fostering a sense of ownership and attachment to their virtual personas. However, the creation of many characters on a GPU can be processing-intensive due to several reasons including, graphic rendering, shader calculations, texture mapping, animation, the number of characters and memory bandwidth. Characters often require complex 3D graphics rendering, which involves creating and manipulating geometric shapes, textures, and lighting effects. Each character may consist of multiple components such as body, clothing, accessories and facial features, each of which requires rendering. Generating many characters simultaneously can put strain on the GPU's memory bandwidth, as textures, shaders and other graphical data need to be transferred between the GPU's memory and processing units.

These problems associated with placing excessive strain on a GPU's memory bandwidth have yet to be fully solved by currently available systems. Additionally, current systems do not incorporate methods for randomizing character characteristics in runtime with memory optimized data.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is directed to a system, methods, devices and media for data optimization and character creation and presentation in different scenarios. Providing optimized data and processing provides numerous advantages to users desiring to render large populations of characters in real-time or runtime by providing the users with a large variability of dynamically created characters, generated in runtime using optimized data which may correspond to only 10 to 50 characters. Further advantages include reduced GPU memory bandwidth for rendering purposes by reducing the need to transfer large amounts of data between the GPU's memory and external processing units utilizing the optimized data. Still further advantages include minimized draw calls to the GPU.

In some embodiments, the present disclosure is directed to a computer implemented method for dynamically improving the performance of real-time rendering systems via an optimized data set, the method comprising: receiving a first input from a user, the first input being in the form of at least one template character comprising a template character shape model and a template character texture model; optionally, receiving a second input from the user, the second input being in the form of at least one attachable associated with the at least one template character; receiving a third input from the user, the third input being in the form of at least one base character model comprising a base character shape model and a base character texture model; and generating, by at least one processor, the optimized data set comprising: optionally, fitting the at least one attachable associated with the at least

one template character to the at least one base character model; converting the at least one base character shape model and the at least one base character texture model to an optimized data set; and generating runtime variations on the optimized data set.

In some embodiments, the present disclosure is directed to an apparatus, including at least one memory storing computer program instructions; and at least one processor configured to execute the computer program instructions to cause the apparatus at least to: receive a first input from a user, the first input being in the form of at least one template character comprising a template character shape model and a template character texture model; optionally, receive a second input from the user, the second input being in the form of at least one attachable associated with the at least one template character; receive a third input from the user, the third input being in the form of at least one base character model comprising a base character shape model and a base character texture model; and generating, by at least one processor, the optimized data set comprising: optionally, fitting the at least one attachable associated with the at least one template character to the at least one base character model; convert the at least one base character shape model and the at least one base character texture model to an optimized data set; and generating runtime variations on the optimized data set.

In some aspects, the present disclosure is directed to a non-transient computer-readable storage medium including instructions being executable by one or more processors to perform a method, the method including: receiving a first input from a user, the first input being in the form of at least one template character comprising a template character shape model and a template character texture model; optionally, receiving a second input from the user, the second input being in the form of at least one attachable associated with the at least one template character; receiving a third input from the user, the third input being in the form of at least one base character model comprising a base character shape model and a base character texture model; and generating, by at least one processor, the optimized data set comprising: optionally, fitting the at least one attachable associated with the at least

one template character to the at least one base character model; converting the at least one base character shape model and the at least one base character texture model to an optimized data set; and generating runtime variations on the optimized data set.

According to various embodiments, the present disclosure is also directed to a method for dynamically improving the performance of real-time rendering systems via an optimized data set, the method comprising: receiving a first input from a user, the first input being in the form of at least one template character comprising a template character shape model and a template character texture model, and a template animation rig; optionally, receiving a second input from the user, the second input being in the form of at least one attachable associated with the at least one template character; receiving a third input from the user, the third input being in the form of at least one base character model comprising a base character shape model and a base character texture model; receiving a fourth input from the user, the fourth input being in the form of at least one animation clip; generating, by at least one processor, an optimized data set comprising: optionally, fitting the at least one attachable associated with the at least one template character to the at least one base character model;

retargeting the template animation rig to the at least one base character model; retargeting the template animation rig to the at least one attachable, in the case where the at least one attachable is received as the second input; converting the at least one base character shape model and the at least one base character texture model to optimized data set; and generating runtime variations on the optimized data set.

According to various embodiments, the present disclosure is also directed to a system for dynamically improving the performance of real-time rendering systems via an optimized data set, the system comprising: at least one processor; and a memory storing processor-executable instructions, wherein the at least one processor is configured to implement the following operations upon executing the processor-executable instructions: receive a first input from a user, the first input being in the form of at least one template character comprising a template character shape model and a template character texture model; optionally, receive a second input from the user, the second input being in the form of at least one attachable associated with the at least one template character; receive a third input from the user, the third input being in the form of at least one base character model comprising a base character shape model and a base character texture model; and generate, by at least one processor, the optimized data set comprising: optionally, fit the at least one attachable associated with the at least one template character to the at least one base character model; convert the at least one base character shape model and the at least one base character texture model to an optimized data set; and generate runtime variations on the optimized data set.

According to various embodiments, the present disclosure is also directed to a system for dynamically improving the performance of real-time rendering systems via an optimized data set, the system comprising: at least one processor; and a memory storing processor-executable instructions, wherein the at least one processor is configured to implement the following operations upon executing the processor-executable instructions: receive a first input from a user, the first input being in the form of at least one template character comprising a template character shape model and a template character texture model, and a template animation rig; optionally, receive a second input from the user, the second input being in the form of at least one attachable associated with the at least one template character; receive a third input from the user, the third input being in the form of at least one base character model comprising a base character shape model and a base character texture model; receive a fourth input from the user, the fourth input being in the form of at least one animation clip; generate, by at least one processor, an optimized data set comprising: optionally, fit the at least one attachable associated with the at least one template character to the at least one base character model; retarget the template animation rig to the at least one base character model; retarget the template animation rig to the at least one attachable, in the case where the at least one attachable is received as the second input; convert the at least one base character shape model and the at least one base character texture model to optimized data set; and generate runtime variations on the optimized data set.

In one aspect, asset fitting may be applied to a base character which allows a user to create attachables (e.g., garments, hats, glasses, etc.) for the base character. The asset may also be fitted for any contemplated variation of the base character body and head.

In a further aspect, the runtime variations may be verified, wherein verification comprises at least one of, verifying the generated characters are correct, verifying the at least one attachable are fitting correctly, verifying the at least one attachable combination usage for intersections, verifying the at least one attachable combines with animations and extreme poses; verifying for UV stretching, verifying bone weight configurations, verifying for optimal mesh construction, verifying for memory usage.

In another aspect, advanced stylization may be applied to a base character which compensates for the difference in scales between the deformations involved in the stylization process thereby avoiding the effect of destroying the likeness and uniqueness of a character when applying a style, such as, for example, a blend shape.

In yet another aspect, character diversity is achieved via a statistical morphable model which may be sampled. The statistical morphable model represents different ethnic traits and ages. In some embodiments, it is also possible to better optimize the range of ethnic variation of a plurality of characters by carefully curating the base characters, depending on the intended application.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example, and not by limitation in the figures of the accompanying drawings, with like references indicating similar elements.

FIG. 1 is a schematic diagram of an example system architecture for practicing aspects of the present disclosure, according to some embodiments.

FIG. 2 is a schematic diagram of an example system architecture for practicing aspects of the present disclosure, according to some embodiments.

FIG. 3 is an illustration of an exemplary method for improving the performance of real-time rendering systems via the creation and rendering systems via an optimized data set, according to some embodiments.

FIG. 4 is an illustration of an exemplary method for improving the performance of real-time rendering systems via an optimized data set, according to some embodiments.

FIGS. 5a-5g illustrate exemplary animatable objects created from the method of character blending, according to some embodiments.

FIG. 6 is a flow diagram of a process for improving the performance of real-time rendering systems via an optimized data set, according to some embodiments.

FIG. 7 is a schematic diagram of an example computer device that can be utilized to implement aspects of various embodiments of the present disclosure.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents.

The present application is directed generally to methods, devices and media for data optimization and character creation and presentation. More particularly, various embodiments of the present disclosure are directed to solutions for improving the functionality of a graphics processing unit (GPU) when compositing and rendering characters. The functionality is improved largely by minimizing draw calls to the GPU through the employment of a novel strategy of minimizing input data to the GPU down to a lowest amount of bytes that can be possibly fed into a rendering system.

In some exemplary embodiments, character characteristics are randomized in runtime with memory optimized data. The present disclosure advantageously produces large variations of character features such as height, weight, ethnicity, asset fitting, art style (e.g., fantasy, cartoon, realistic, low-poly, etc.), and different animation rigs in real-time or runtime from an optimized character set. A hash table of compacted data is created which minimizes the memory footprint on the GPU, thus making the GPU more efficient.

The present disclosure also advantageously makes a GPU more efficient in other aspects such as the tasks of compositing and rendering. This efficiency is largely achieved by minimizing draw calls through the utilization of the afore-mentioned memory optimized data. As is well known, draw calls are fundamental to the rendering process in real-time computer graphics engines, such as those used in video games and interactive applications. The draw calls are responsible for initiating the rendering pipeline, where vertices are transformed, shaded, and eventually rasterized into pixels on the screen. Each draw call typically involves specifying the geometry, textures, shaders, and other parameters necessary to render the objects on the screen. Efficient management of draw calls is crucial for achieving good performance in graphics applications, as each draw call incurs overhead in CPU-GPU communication and processing. Strategies such as batching, instancing, and culling are often employed to optimize draw call usage and improve rendering performance. Aside from these well-known strategies, the present disclosure employs a unique and novel method of memory optimization that incurs numerous computing efficiency benefits, including but not limited to, minimizing the amount of draw calls communicated to a graphics processing unit (GPU). By minimizing the input data that can be possibly fed into a rendering system down to a lowest amount of bytes the GPU becomes more efficient in numerous aspects including, but not limited to, reducing overhead, optimizing resource usage, maximizing parallelism, improving rendering performance and conserving CPU resources, amongst other advantages. Moreover, by reducing the number of draw calls, the overhead associated with each draw call, such as state changes and CPU-GPU communication is minimized. Each of these computing efficiencies achieved via memory optimization are further described in greater detail as follows.

Reduced overhead is achieved by reducing the number of draw calls via memory optimization. As is well known, each draw call comes with its own overhead, including CPU-GPU communication, state changes, and setup time. Minimizing draw calls reduces this overhead, allowing the GPU to spend more time actually rendering pixels, which leads to better performance.

Resource usage is optimized by reducing the number of draw calls via memory optimization. As is well known, GPUs work most efficiently when they can process large batches of geometry and textures at once. By reducing the number of draw calls, multiple objects may be batched together, which allows the GPU to make better use of its resources, such as vertex buffers, texture memory, and shader programs.

Parallel processing is optimized by reducing the number of draw calls via memory optimization. As is well known, GPUs excel at parallel processing, but excessive draw calls can introduce synchronization points that limit parallelism. By minimizing draw calls and batching work together, parallelism can be maximized to take full advantage of the GPUs processing capabilities.

Rendering performance is improved by reducing the number of draw calls via memory optimization. By improving rendering performance, a GPU can spend more time rendering pixels and less time waiting for instructions from the CPU. This can result in smoother frame rates and improved overall rendering performance, especially in real-time applications like games.

CPU resources may be conserved by reducing the number of draw calls via memory optimization. Draw calls often involve CPU processing to prepare and issue rendering commands. By minimizing draw calls, the CPU workload can be reduced thereby freeing up resources for other tasks such as AI, physics or game logic.

The present embodiments are, therefore, to be considered in all respects as illustrative and not restrictive, and all changes coming within the meaning and equivalency range of the appended claims are intended to be embraced therein.

Additionally, exemplary embodiments include quantization of data (e.g., an ability to choose dynamically what characteristics are blended at a distance) to allow for graceful degradation and ability to support thousands of characters in runtime. Such techniques may produce several thousands of unique characters (different from each other) using data corresponding to only 10 to 50 characters. Depending on the level of quality needed, especially on the facial animations, a memory optimization step can be performed on the client side, server side or a combination of both.

### Terminology

The term “template character” as referred to herein, may refer to a defined shape geometry, materials, texture model and skeleton that defines all characters produced by the system and method of the present disclosure.

The term “attachable” as referred to herein, may refer to a 3D asset that is fitted and associated with a specific template character. Attachables may include, for example, garments, hair, accessories, props, overlays and other 3D assets, well known in the art. An attachable can also have its own skeleton to be attached to a bone of a template character.

The term “base character” as referred to herein, may refer to a representing a variation of a template character in shape (e.g., a tall version) and/or in texture (e.g., a darker skin tone). The base character is intended to be used to create a minimal data set (i.e., optimized data) from which all other character variations may be derived from. For some operations, like character blending and character stylization, references made to a base character also refers to a template character.

The term “optimized data set” as referred to herein, may refer to a data package (set) of all template characters, base characters and attachables that have been optimized to minimize the input data to fed into a rendering system down to the lowest amount of bytes (e.g., by removing unused asset combinations, compressed formats, culling, etc.). The optimized data set for use in performing pre-calculations on the data (e.g., culling masks, wraps, fitting, retargeting) and transforming into efficient representation for the composition and rendering step.

The term “animation rig” as referred to herein, may refer to a set of controls on a character that allows the character to be animated. The animation rig, sometimes referred to as a “skeleton”, can contain, but is not limited to, virtual bones, joints, blend-shapes, deformers and hierarchy, allowing the character to move. To draw an analogy, an animation rig can be thought of as the strings on a marionette. The purpose of an animation rig is to provide means to manipulate a model realistically. The animation rig typically includes controls that allow animators to move and rotate the various parts of the character, such as limbs, joints, and facial features. These controls are often represented by on-screen widgets or manipulators that can be clicked and dragged to pose the character in different positions.

The term “generating runtime variations” as referred to herein, may refer to a new character that is generated from an optimized data set, as defined herein. The generation is usually performed by blending between a template character and one or more base characters, and by further selecting one or more adjusted attachable. A runtime variation of a can usually be represented by a small set of character descriptors and is thus a very efficient way of representing large populations of characters.

The term “character descriptors” as referred to herein, may refer to a minimum set of properties which define how to display a runtime variation. These properties may include, without limitation, a template ID, shape weights, attachable IDs.

The term “culling data” as referred to herein, may refer to a process of removing objects or elements from a scene that are not visible to the camera or are outside the view frustrum. This technique is commonly used to optimize rendering performance by reducing the number of objects that need to be processed and drawn by the graphics hardware. There are several types of culling techniques commonly used in computer animation. They include, view frustrum culling, backface culling, occlusing culling, and level of detail (LOD) culling. By applying culling techniques effectively, developers can significantly improve the performance of real-time rendering systems, allowing for smoother animation and higher frame rates, especially in complex scenes with many objects.

The term “creating character groups” as referred to herein, may refer to a group of characters defined by ranges and constraints applied to the variations that are allowed for the characters in that group, (e.g., create a group of tall, male, firefighters that use only firefighter garments). This allows for different sets of characters with unique themes.

The term “shape model” as referred to herein, may refer to a computerized model of a 3D shape representing, for example, a human body, a fantasy creature, a piece of garment, etc. Meshes are the most common shape models in computer graphics. Other popular shape models include NURBS or level sets.

The term “texture model” as referred to herein, may refer to a computerized model of a 3D shape appearance representing, for example, color, bumpiness, specularity, gloss, transparency, and other visual properties that contribute to the overall look of the 3D object. A texture model generally consists of a set of 2D digital images that are applied to the surfaces of 3D objects to enhance their appearance and realism.

The term “draw calls” as referred to herein, may refer to a command sent to a GPU to render a batch of geometry using a specific material and shader program. Multiple draw calls are typically issued to render all the objects in a scene.

The term “instance data” as referred to herein, may refer to additional information associated with each material/mesh instance that may be needed during the rendering process. This data may include parameters such as shader constants, texture mappings, shader inputs, character descriptors or any other settings specific to the material instance.

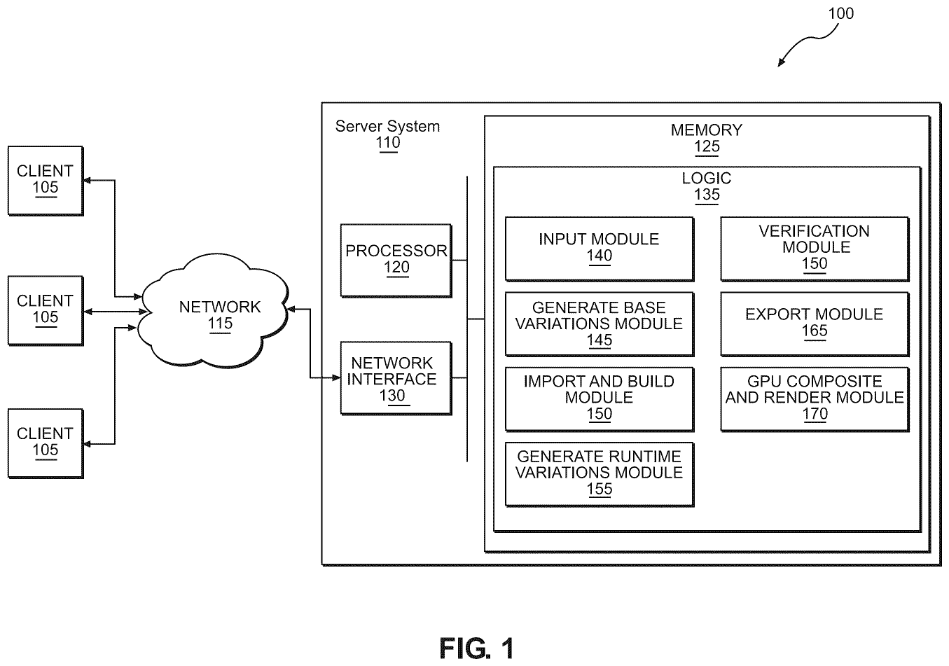

FIG. 1 illustrates an exemplary architecture 100 for practicing aspects of the present disclosure, according to one embodiment. The architecture 100 comprises one or more clients 105 communicatively coupled to a server system 110 via a public or private network, such as network 115. In various embodiments, the client 105 includes at least one of a personal computer, a laptop, a Smartphone, or other suitable computing device.

Suitable networks for network 115 may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 115 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

Generally, the server system 110 is configured to provide various functionalities which are described in greater detail throughout the present disclosure. In various embodiments, the server system 110 comprises a processor 120, a memory 125, and network interface 130. According to some embodiments, the memory 125 comprises logic 135 (otherwise referred to as instructions) that may be executed by the processor 130 to perform various methods described herein. For example, the logic 135 may include one or more program modules 140-170 which carry out the execution of the described methods. The program modules include input module 140, generate base variations module 145, import and build module 150, generate runtime variations module 155, verification module 160, export module 165 and GPU composite and render module 170. The program modules 140-170 are configured to carry out the functions and/or methodologies of embodiments of the invention as described herein.

It is to be understood that, while the methods described herein are generally attributed to the server system 110, may also be executed by the client 105. In other embodiments, the server system 110 and client 105 may cooperate to provide the functionalities described herein. The client 115 may be provided with a client-side application that interacts with the server system 110 in a client/server relationship.

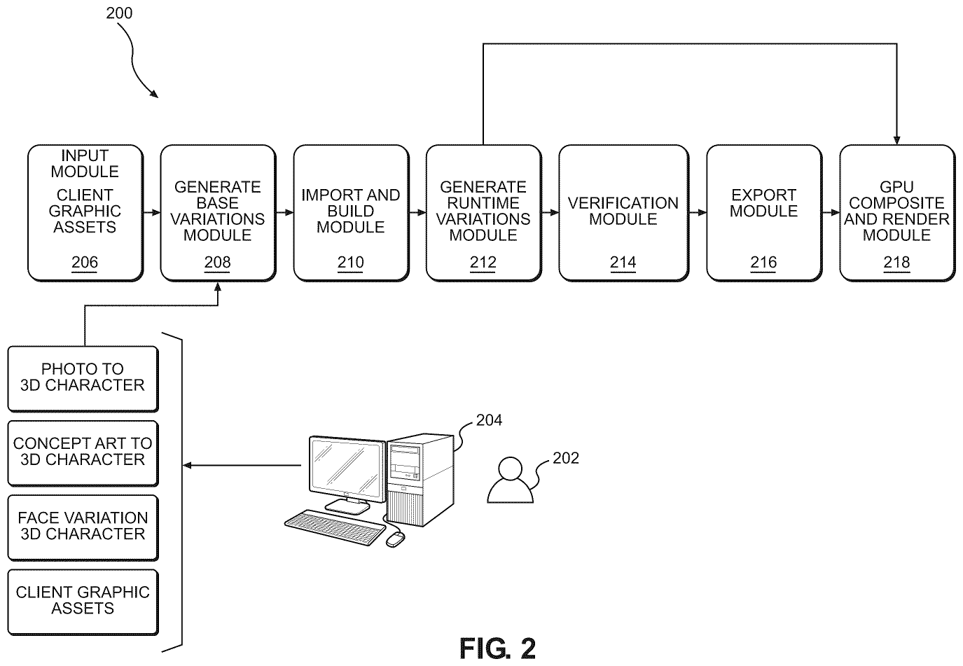

FIG. 2 illustrates a further exemplary system architecture 200 for practicing aspects of the present disclosure, according to one embodiment. The architecture 200 comprises a single user 202 operating computerized device 204. Computerized device 204 is shown in the form of a general-purpose computing device. The components of the computerized device 204 may include, but are not limited to, one or more processors or processing units, a system memory, and a bus that couples various system components including the system memory to the processor. Computerized device 204 typically includes a variety of computer system readable media. Such media may include both volatile and non-volatile media, removable and non-removable media. System memory can include computer system readable media in the form of volatile memory, such as random-access memory (RAM) and/or cache memory. Computerized device 204 may further include other removable/non-removable, volatile/non-volatile computer system storage media. By way of example only, the storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided.

One or more program modules 206-218 may be stored in the computerized memory by way of example, and not limitation, as well as an operating system, one or more application programs, other program modules, and program data. Each of the operating system, one or more application programs, other program modules, and program data or some combination thereof, may include an implementation of a networking environment.

Program modules 206-218 carry out the functions and/or methodologies of embodiments of the invention as described herein.

A process flow for dynamically generating a large population of varied characters in real-time or runtime utilizing optimized data may be executed by program modules 206-218 which begins with input module 206 configured to receive user inputs in the form of client graphic assets including a user provided shape model of a character, referred to hereafter as a template character. Notably, a template character generally refers to the underlying structure or framework of a 3D model. It represents the arrangement of vertices, edges, and polygons that form the basic shape of the character before any detailed sculpting or texturing is applied. Preferred base topologies preferably have evenly distributed geometry, with appropriate edge loops and vertex placement to allow for smooth deformation during animation, such as bending limbs or facial expressions.

In addition to receiving the base template at input module 206, input module 206 is further configured to receive one or more client graphic assets. The one or more client graphic assets include, for example, and not by way of limitation, (a) models to wear on the template such as, for example, garments, hair shoes, (b) models to attach to the template, sometimes referred to as attachables, (e.g., horns, tails, wings), (d) images for skin decals, sometimes referred to as overlays (e.g., tattoos, marks, scars, eyelashes), (c) animation clips to be retargeted, (f) models for the characters to use, sometimes referred to as props.

Input module 206 outputs the template character and any additional client graphic assets to base variations module 208 which is configured to operate on the template character and additional client graphic assets from which characters, referred to as base characters, are generated based on the template character while retaining art style, technical specifications (e.g., mesh, topology, rig structure, texture maps, etc.) and client asset configurations. In various embodiments, variations to be applied to the template character may include, for example, (a) facial geometry shaping (e.g., ethnicity, age, weight), (b) skin coloring and texturing (e.g., ethnicity, age, weight), (c) body geometry shaping (e.g., muscular, age, weight, height, posture), (c) attachable variation (e.g., combinations, shapes, colors). In some embodiments, base data variation may use various forms of user supplied input including, for example, Base variations module 208 may receive as further inputs, certain user inputs which may include, (a) photo to 3D characters, (b) concept art to 3D character, (c) face variation 3D character, and (d) client graphic assets, as shown in FIG. 2.

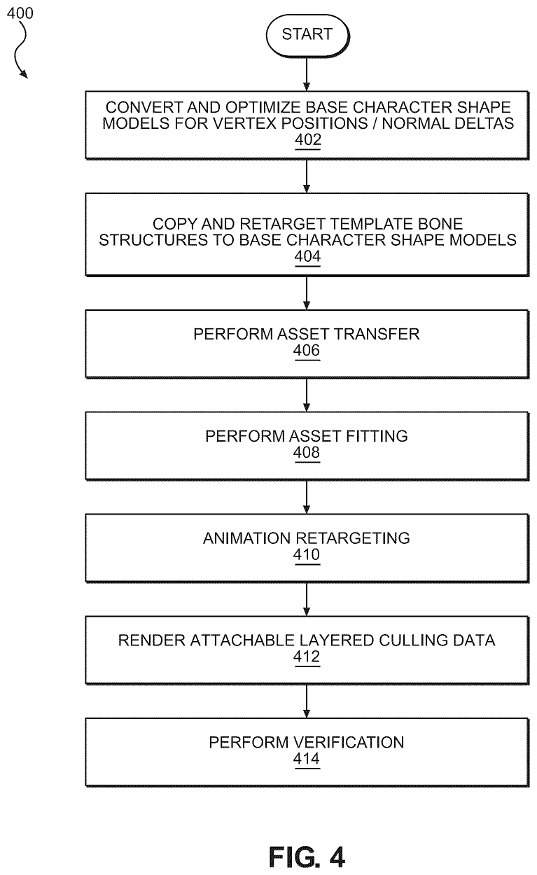

Import and build module 210 imports the client graphic assets output from the input module 206 and base characters output from the base variations module 208 to build an optimized data set. Specific details regarding the building of an optimal data set are described below with reference to FIG. 4.

Generate runtime variations module 212 is configured to generate runtime variations based on the optimized data generated by import and build module 210. In some embodiments, generating runtime variations comprise at least one of, (a) creating character groups, which are units of different constraints and ranges, (b) constraining the facial and body shapes and skin, (c) constraining the use of the attachables, and combinations thereof, (d) constraining the colorization of assets, (e) constraining the texture decals used on the character template and attachables, and (f) generating character blends between template characters, base characters and attachable configurations and recoloring.

Verification module 214 comprises one part of the verification process. Notably, verification is performed as an optional step, and when in use, the verification module 214 is configured to verify the correctness and specification of all runtime variations, template characters, base characters and attachables automatically. In various embodiments, verification can include steps such as, for example, testing for combinations of attachables for visible intersections, verifying the characters are correct, verifying the at least one attachable is fitting correctly, verifying the at least one attachable combination usage for intersections, verifying the at least one attachable combines with animations and extreme poses, verifying for UV stretching, verifying bone weight configurations, verifying for optimal mesh construction and verifying for heavy memory usage. Heavy memory usage is defined herein as a data size that occupies most or all of the available RAM on the CPU or VRAM on the GPU. Export module 216 exports optimized data so that it can be read back in. Typically, exportation of the optimized data is made to disk to be read by GPU composite and render module 218. However, exportation is not limited to disk.

GPU composite and render module 218 composites and renders characters simultaneously in the GPU. Rendering is the process of generating an image from a 2D or 3D model through computer software. This process involves calculations to determine the color, lighting, shadows, texture, and other visual elements of the scene. Rendering takes into account the position of virtual cameras, light sources, and objects in the scene to produce a realistic or stylized final image. Compositing is the process of combining multiple layers or elements from rendered images or videos to create the final visual output. These layers can include rendered frames, live-action footage, computer-generated imagery (CGI), visual effects (VFX), and various other elements such as text or graphics overlays. Compositing involves tasks such as layering, masking, blending, color correction, and adding visual effects to achieve the desired look and feel of the final image or sequence.

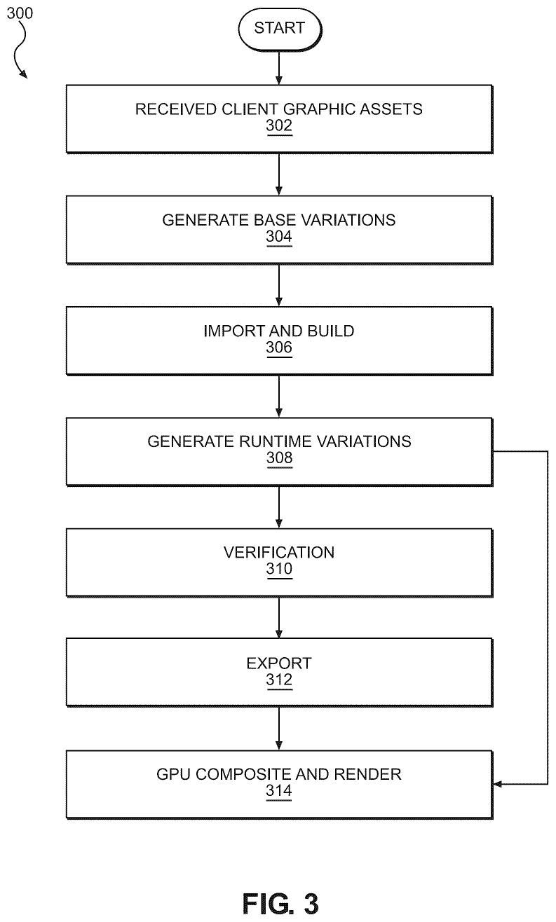

FIG. 3 is a flow chart showing an exemplary method 300 for dynamically improving the performance of real-time rendering systems via an optimized data set.

Method 300 can be performed by processing logic that includes hardware (e.g. decision-making logic, dedicated logic, programmable logic, application-specific integrated circuit), software (such as software run on a general-purpose computer system or dedicated machine), or a combination of both. In one example embodiment, the processing logic refers to one or more elements of the system shown in FIG. 1.

Operations of method 300 recited below can be implemented in an order different than described and shown in FIG. 3. Moreover, the method 300 may have additional operations not shown herein, but which can be evident to those skilled in the art from the present disclosure. Method 300 may also have fewer operations than shown in FIG. 3 and described below.

The method 300 may commence in operation 302, with receiving user input comprising graphic assets. In various embodiments, the user input includes at least one of an image, a video signal, and a 3D scan, which may be indicative of a face and/or body of a user. In certain embodiments, the user input is received from a client device via a network. In certain embodiments, the user input is received from a non-networked client device directly coupled to system 100 of FIG. 1. It is to be understood that each operation of the method 300 may be performed in real-time or runtime, such that user inputs (e.g., graphic assets) is permitted to be input to automatically generate a large population of varied characters using optimized data.

Operation 304—generate base variations—includes automatically generating base variations of the base topology of the character model input at operation 302, referred to herein as a template character. In one or more embodiments, the base data variations are generated based from the template character while retaining art style, technical specifications (e.g., mesh, topology, rig structure, etc.) and client asset configurations. In various embodiments, base data variations may include, for example, (a) facial geometry shaping (e.g., ethnicity, age, weight), (b) skin coloring and texturing (e.g., ethnicity, age, weight), (c) body geometry shaping (e.g., muscular, age, weight, height, posture), (e) attachable variation (e.g., combinations, shapes, colors). In various embodiments, base data variation may use various forms of input including, for example, a real photo of a person, concept art, and descriptive keywords.

Operation 306—import and build—proceeds with importing and building optimized data based on the imported client graphic assets and base data variations. Operation 306 is described in greater detail below with regard to the detailed flowchart of FIG. 4.

Operation 308—generate runtime variations—comprises generating runtime variations in the character model (i.e., template) based on the optimized data built at operation 306. In one or more embodiments, generating runtime variations comprises at least one of, (a) creating character groups, which are units of different constraints and ranges, (b) constraining the facial and body shapes and skin, (c) constraining the use of the attachables, and combinations thereof, (d) constraining the colorization of assets, (e) constraining the texture decals used on the template character and attachables, and (f) generating blends between base characters and attachable configurations and recoloring.

Operation 310—verification—performed as an optional step, configured to verify the correctness and specification of all runtime variations, template characters, base characters and attachables automatically. In various embodiments, verification can include steps such as, for example, testing for combinations of attachables for visible intersections. In various embodiments, verification can include steps such as, for example, testing for combinations of attachables for visible intersections, verifying the characters are correct, verifying the at least one attachable is fitting correctly, verifying the at least one attachable combination usage for intersections, verifying the at least one attachable combines with animations and extreme poses, verifying for UV stretching, verifying bone weight configurations, verifying for optimal mesh construction and verifying for heavy memory usage.

Operation 312—export—optimized data is exported so that it can be read back into a renderer which can be a different application. Typically, exportation of the optimized data is made to disk to be read by GPU composite and render module 218. However, exportation is not limited to disk. In some embodiments, exportation may be directed through a network using a socket to a remote renderer app.

Operation 314—GPU composite and render—comprises crowd and multi-character rendering. More particularly, operation 314 renders a large number of characters in real time or run time from a limited number of existing 3D models, which may be comprised of template and base characters. For example, it is possible to render thousands of characters using a minimal set of base characters. For example, it is possible to render thousands of characters using 10-50 base characters. This is achieved via the data optimization methods described herein together with uniquely combined computer graphic techniques (e.g., GPU composition, compressed texture arrays, skin compression, colorized index maps and compressed animation format) to represent multiple character data while minimizing the memory footprint and GPU draw calls.

In addition to providing capabilities for dynamically generating a large population of characters in real-time or runtime utilizing optimized data, the present disclosure provides three complementary methods for generating the runtime variations in the character model. In this regard, these complementary methods are associated with generate runtime variations module 155, 212, as shown in FIGS. 1 and 2. These complementary methods include, character blending, stylization, and optimal base character selection.

In some embodiments, asset fitting may be applied to a template character which allows a user to create assets (e.g., garments, hats, glasses, etc.) for the template character. The asset may also be fitted for any contemplated variation of the template character body and head. In various embodiments, asset fitting may include steps of refitting and retargeting all attachables to different templates which may include transferring bone structure and bone weights to meshes and textures.

In the context of computer animation, asset fitting typically refers to a process of integrating or adapting digital assets, such as character models, props, or environments, into a specific animation project or scene. Some common aspects of asset fitting in computer animation include scaling and positioning, rigging and skinning, texture mapping, animation integration, optimization and quality assurance. Rigging involves creating a digital skeleton (rig) and attaching it to the character model, while skinning involves assigning vertices of the model to the corresponding bones of the rig.

### Character Blending

In one embodiment, efficient character variations are generated based on a method generally referred to as character blending in which the pre-existing template character shape models and texture models are combined to produce a unique character. This approach is highly memory efficient by virtue of combining or blending a minimal amount of real-valued weights assigned to the respective templates under consideration for use. The method advantageously produces varied shapes by not constraining the weights to be positive and sum to one. Accordingly, the novel shape blending method relaxes the range constraints on weights by enabling negative weights and weights greater than one, the output shape is ensured to be anatomically plausible by controlling shape variations with respect to an implicit average shape.

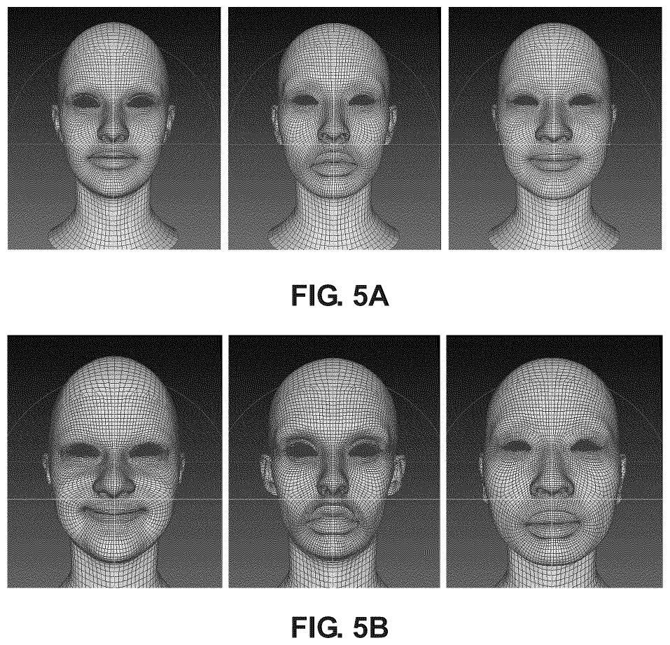

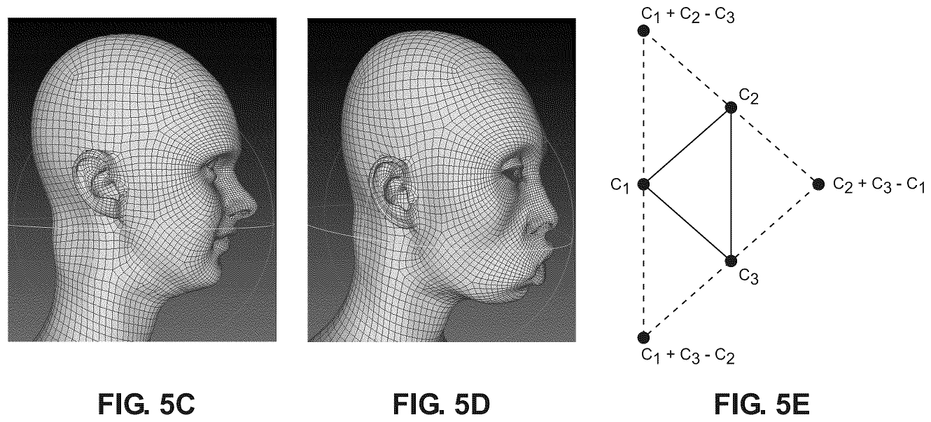

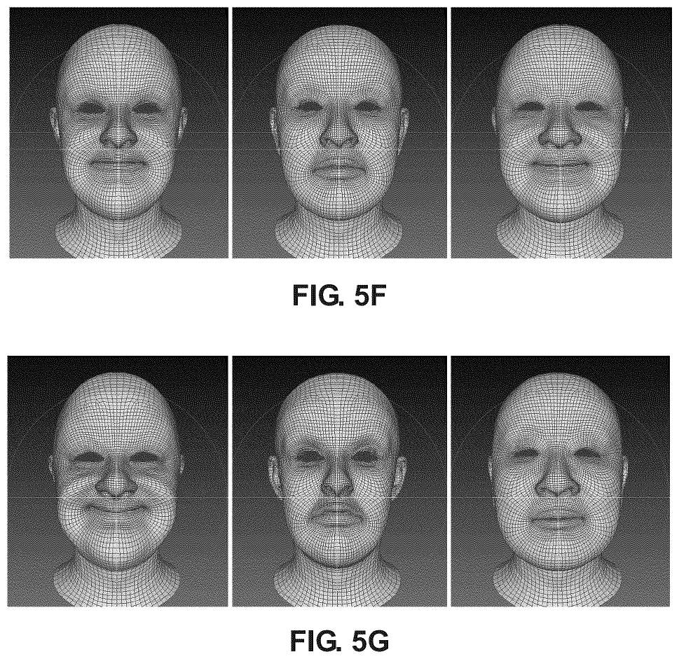

By way of example, a method of character blending will be described with reference to the three distinct character shapes C1, C2, and C3 shown in FIG. 5a. The method of character blending to be described pertains to how to blend the three exemplary character shapes C1, C2, and C3 to create multiple new character shapes in the context of fulfilling certain requirements including, Linearity, Unbiasedness, Correctness and Variability, defined as follows.

The requirement of linearity stipulates that Blends should be linear in the input characters C1, C2 and C3 for both computational efficiency and memory optimization. The requirement of unbiasedness stipulates that blends should only involve the three specified characters C1, C2, C3, and should therefore not depend on any other character shape (e.g., the base template). The correctness requirement stipulates that all blends generated by the method should be geometrically correct, i.e., if the input characters are human heads, the blends should remain visually plausible human heads. The requirement of variability stipulates the blends should cover a broad range of diverse shapes. Stated otherwise, the characters generated by the method should look different from one another.

The method operates under the following assumption. For each permutation Ci, Cj, Ck of the three input characters C1, C2, C3, the shape Ci+Ck−Cj is geometrically correct. This assumption is based on the empirical observation that Ck−Cj generally defines a valid delta blendshape that can be applied to any independent initial shape. Independence being defined only in a loose statistical sense.

The afore-mentioned assumption may be characterized by the following statement—the delta blendshape C3−C2, if applied to the character C1, will produce a correct shape, namely, C1+C3−C2. However, it is not assumed that the same delta C3−C2 necessarily produces a correct shape if applied to C3. In this case, the initial shape C3 is the same as the delta blendshape's endpoint, and is therefore dependent on the blendshape. The resulting shape C3+ (C3−C2) bears the risk of being geometrically incorrect. This is because C3 is bound to have larger variance than C1+C1 if all characters have the same variance and are mutually independent. Under these assumptions, the variance of 2C3 is actually twice as large as that of C1+C3. It should be noted that while these independent assumptions may not strictly hold in practice, they suggest that shapes of the form 2Ci−Cj, for any pair of distinct template characters Ci and Cj, may have excessive statistical variability in practice.

The empirical considerations are best illustrated with regard to the three characters shown in FIG. 5b. The three characters, C1, C2, C3 represent Caucasian, African and East Asian adult females, respectively. There are three possibilities of augmented shapes of the form Ci+Ck−Cj based on the permutations of C1, C2, C3, all leading to fairly extreme, yet visually plausible shapes. However, one should rule out the non-independent augmented shapes of the form 2Ci−Cj due to their high statistical variability. For example, the figure shown in FIG. 5c exhibits an implausible neck shape. Similarly, the shape 2C2−C3 as shown in FIG. 5d has a strange neck and cheek deformation, as well as a fairly egg-shaped skull.

Based on the above assumptions, the method proposes to sample shapes within the triangle defined by the dotted lines in the sketch shown in FIG. 5e. This relies on the additional assumption that any weighted average of correct shapes is also a correct shape, which also stems from common empirical observation. As such, the method may be expressed in the form of an algorithm which states,
1. Generate positive coefficients a1, a2, a3 with unit sum.
2. Output the shape s=a1(C3+C2−C1)+a2(C1+C3−C2)+a3(C1+C2−C3)

It is noted that the output shape can be rewritten as a linear blend of the input character shapes:

$$S = w 1 C 1 + w 2 C 2 + w 3 C 3$$

with

$$w 1 = a 2 + a 3 - a 1$$

$$w 2 = a 1 + a 3 - a 2$$

$$w 3 = a 1 + a 2 - a 3$$

However, since the coefficients a1, a2, a3 have unit sum, the weights w1, w2, w3 can be expressed more simply as:

$$w 1 = 1 - 2 a 1 ,$$

$$w 2 = 1 - 2 a 2 ,$$

$$w 3 = 1 - 2 a 3$$

It is easy to verify that the weights w1, w2, w3 are in the range (−1,1) and sum up to one as well. They differ from classical weighted average weights in that they can be negative.

Examples of admissible weights w1, w2, w3 are as follows.
(⅓, ⅓, ⅓), (0.5, 0.5, 0), (1, 0, −1), (−0.5, 1, 0.5), (−1, 1, 1), (−2, −1, 4), etc.

The method clearly satisfies both the linearity and unbiasedness requirements stated above. There is no strict theoretical guarantee of correctness and variability, but empirical evidence suggests that these properties are generally satisfied in practice.

### Global Blendshapes

When a global blendshape (combining age, weight, style, etc. . . . ) is considered, it is natural to apply it to each of the three input characters before applying the proposed blending method. The blending then operates on modified characters C1′, C2′, C3′ that result from applying the global blendshape to C1, C2, C3, respectively, so that all modified characters share the features brought in by the global blendshape. For example, FIG. 5f illustrates three versions of the female characters illustrated in FIGS. 5a and 5b obtained by applying half the fat and half the old blendshapes. Notably, the three extreme augmented shapes derived from the shapes of FIGS. 5a and 5b still look correct, as shown in FIG. 5g.

Notably, it does not matter whether the global blendshape is applied before or after generating the extreme shapes. In other words, the shapes

$$C {1}^{′} + C {3}^{′} - C {2}^{′} , C {1}^{′} + C {2}^{′} - C {3}^{′} , C {2}^{′} + C {3}^{′} - C {1}^{′}$$

are respectively the same shapes as one would get by applying the global blendshape to the augmented shapes

$$C 1 + C 3 - C 2 , C 1 + C 2 - C 3 , C 2 + C 3 - C 1$$

derived from the initial characters. This implies that by simply applying the global blendshape to every sample produced from the initial characters using the proposed method, a statistically equivalent outcome would result as a consequence of the invariance property.

### Texture Blending

Negative weights should not be used for texture blending as they could lead to undesired effects. Therefore, if T1, T2, T3 denote the textures respectively associated with C1, C2, C3, they will not be blended using the same weights as computed above for shape blending, via T=w1T1+w2T2+w3T3 if at least one of those weights is negative. Instead, specific weights for texture blending may be computed as follows: (1) cancel each negative weight, define wt1=w1 if w1>0 else wt1=0. This step simply copies the shape weights if they are all positive. (2) normalize all weights to unit sum: wt1 is replaced by the normalized weight: wt1/(wt1+wt2+vt3), and likewise for wt2 and wt3. Notably, this has no effect if the weights are positive, provided they sum to one. The resulting texture weights wt1, wt2, wt3 are suitable for blending using a weighted sum of textures since they are now positive with unit sum.

### Generalization to an Arbitrary Number of Template Characters

The above-described weight selection methods for shape blending and texture blending methods are described with three template characters for the sake of clarity, but are straightforwardly extended to an arbitrary number of input templates. In the case where N templates are available, with N an arbitrary integer, the shape weights w1, w2, . . . , wN are selected in the range (−1, 1) under the constraint that they sum up to one. The texture weights are selected in the range (0, 1) under the constraint that they sum up to one.

In various embodiments, the process of asset fitting is employed to provide capabilities to adjust any 3D attachable (e.g., garments, accessories, hair, props, etc.) created for a template character to fit any of the runtime variations of that character. This process of asset fitting is comprised of two stages.

At a first stage, the template attachable asset is adjusted to each of the base characters. This step is performed automatically by interpolating the spatial displacements from the source template character for which the asset was created to any base character using a dense multidimensional interpolation method, such as thin plate spline or k-nearest neighbor interpolation and applying the interpolated displacements to the source attachable. The interpolated displacements may be further regularized in some user-defined regions to enforce rigidity or stiffness constraints, e.g., to preserve the shape of a pair of glasses or a gas tank when adjusted to a new character.

At a second stage, the attachables are fitted to the runtime character variations created by blending and/or stylization of several base characters by applying the blending and/or stylizing to the attachables respectively fitted to the base characters in the first stage.

### Stylization

In one embodiment, efficient character variations are generated based on a method generally referred to as stylization in which a unique character is produced by bringing a given character into the “style” of an existing template character. In one aspect, stylization may be viewed as a special case of blending, however, stylization requires the additional step of shape scaling. The process of stylization generally operates by selecting two templates in respective categories, (e.g., human and orc) and brings the two templates into comparable scales using conventional shape registration methods, such that the difference between their rescaled shapes reflects the key differences in styles. Stylization is then applied to another human character by first rescaling this human character to the orc scale previously estimated and then adding the shape difference.

Specifically, given two template meshes, a source mesh S1 (representing, e.g., a human character) and a target mesh S2 (i.e., the “style”), stylization starts with the estimation of a spatial transformation that aligns the source mesh vertices with the target mesh vertices. This can be accomplished using a conventional registration method such as least square point registration. Importantly, the transformation search space considered in this step should be large enough to compensate for the difference in scale between the source and target, but constrained enough not to compensate for the vertex displacements relevant to the style difference. Possible choices of transformation search space include similarity transformations (9-parameter rigid-body transformations with additional global scaling), affine transformations, or approximating thin-plate splines.

Now, given a character mesh C (in the same style as S1, but different) to be stylized according to S2, the stylization process consists of transforming the vertices in C according to C′=T(C)+S2−T(S1), where T is the transformation found in the registration step of S1 onto S2. This transformation boils down to first bringing the character C to the same scale as S2 via the transformation T, and then adding the delta blendshape S2−T(S1), which represents the residual shape difference between the source and target, and therefore encodes for the key local shape differences between the source and target styles.

### Optimal Base Character Selection

In one embodiment, efficient character variations are generated based on a method generally referred to as optimal base character selection in which the number of pre-existing base character 3D models in the system is limited. According to the method, in a scenario in which a large number of 3D base characters are created by 3D artists or using a fully automated character creation pipeline such as the one developed by Didimo, it is necessary to pre-select base characters in such a manner that the real-time rendering performance of the system is guaranteed while the variability of characters the system can produce is maximized. See, Reference: Dias, M., Roche, A., Fernandes, M., & Orvalho, V. (2022). High-fidelity facial reconstruction from a single photo using photo-realistic rendering. In ACM SIGGRAPH 2022 Talks, incorporated by reference herein in its entirety. To achieve this end, a template selection method is provided which automatically identifies a few “extreme” characters within a given set, such that character blending covers as much variability as possible.

### Real Distribution Estimation

For a given subset of templates that we want to represent by a few “extreme” shapes, we start by forming an estimate r-hat(x) of the distribution of face shapes in this subset, where x is the mathematical variable representing the representation; where x is the mathematical variable representing the representation; x may be an array of vertex coordinates, or a higher-level representation, such as a vector of coefficients associated with a morphable model. The distribution estimate may be produced using a conventional distribution estimation technique, either parametric such as a Gaussian distribution fitting, or non-parametric such as the Kernel Density Estimation method.

### Objective Function

The final step to complete the problem definition is to define what “as close as possible” means when comparing the character tool sampling distribution and the estimated shape distribution representative of the template subset. To this end, the Kullback-Leibler divergence between the character sampling probability density s(x) and the estimated probability density r(x) is employed.

$$KL ( s \vert \vert r ) = {\int }_{χ} s ( x ) log ( \frac{s ( x )}{\hat{r} ( x )} ) dx$$

While the Kullback-Leibler divergence is computationally intractable, it can be approximated using a Monte Carlo sampling approach, hence defining a Kullback-Leibler divergence proxy:

$$KL ( s \vert \vert \hat{r} ) \approx K {L}_{proxy} ( s \vert \vert \hat{r} ) = \frac{1}{J} {\sum }_{j = 1}^{J} log \frac{s ( {x}_{j} )}{\hat{r} ( {x}_{j} )}$$

Where xj are a set of j points sampled independently from the distribution s(x).

The sampling distribution s(x) is considered to be “as close as possible” to the population distribution estimate r-hat(x) when the KL divergence is minimized. The goal is therefore to find the N optimal templates, where N is a pre-defined number, for which the sampling distribution s(x) minimizes the Kullback-Leibler divergence proxy:

$${min}_{s} [ \frac{1}{J} {\sum }_{j = 1}^{J} log \frac{s ( {x}_{j} )}{\hat{r} ( {x}_{j} )} ]$$

This optimization problem can be solved numerically by any standard optimization algorithm, including gradient based solvers, since the gradient of the KL divergence proxy with respect to the templates can be easily computed using any auto-grad package.

FIG. 4 is a flow chart showing detailed steps of a method 400 for building an optimized data set, as generally indicated at step 306 of the flow chart of FIG. 3. Method 400 can be performed by processing logic that includes hardware (e.g. decision-making logic, dedicated logic, programmable logic, application-specific integrated circuit), software (such as software run on a general-purpose computer system or dedicated machine), or a combination of both. In one example embodiment, the processing logic refers to one or more elements of the system shown in FIG. 1.

Operations of method 400 recited below can be implemented in an order different than described and shown in FIG. 4. Moreover, method 400 may have additional operations not shown herein, but which can be evident to those skilled in the art from the present disclosure. Method 400 may also have fewer operations than shown in FIG. 4 and described below. Further, method 400 may include only one or more of the operations shown herein.

The method 400 may commence in operation 402 with converting/optimizing all shape models for vertex positions/normal deltas. This step is sometimes referred to herein as blendshapes. In general, blendshapes, also commonly known as morph targets or shape keys, are used to create smooth transitions between different shapes or poses of a 3D model that is initially created in a neutral pose or shape (i.e., template). Additional poses or shapes, (e.g., targets or blend shapes) are then created to represent different expressions, emotions or deformations. These targets represent variations of the neutral pose, such as a smile, a frown or a raised eyebrow.

Operation 404 includes copying and retargeting template character bone structures to shapes and attachables.

Operation 406 may include performing an asset transfer which comprises refitting all attachables to the shapes, optimized blendshapes to unique fits.

Operation 408 may include refitting and retargeting all attachables to different template characters, which can include, for example, transferring bone structure/bone weights to meshes and textures.

Operation 410 may include animation retargeting which comprises adjusting the template character animation rig to the base character shape so that the base character can be animated similarly to the template. This is a known computer graphics topic, we can cite a few publications: Pighin, F., & Lewis, J. P. (2006). Facial motion retargeting. In ACM SIGGRAPH 2006 Courses (pp. 2-es), Poirier, M., & Paquette, E. (2009 May). Rig retargeting for 3D animation. In Graphics interface (pp. 103-110), Song, J., & Noh, J. (2014). Body Motion Retargeting to Rig-space. Journal of the Korea Computer Graphics Society, 20(3), 9-17, incorporated herein by reference in its entirety.

Operation 412 may include rendering attachable layered culling data which comprises a process of removing objects, draw calls, and pixels that do not contribute to the final picture in 3D rendering. Data culling serves to limit the amount of data ultimately produced and sent to the rendering step, in order to improve rendering efficiency and reduce resource waste. For example, when layering attachables the under layers that are not seen, can be culled by generating data that marks it as so. In some embodiments, culling may be performed by Z-buffer culling (Depth Culling), Occlusion Culling, Level of Detail (LOD) culling, Bounding Volume Culling, as well as other culling techniques well known in the art.

In accordance with some embodiments, the culling process is divided into multiple layers or stages to efficiently determine the visibility of objects or elements within a scene. This process is employed to optimize rendering performance, particularly in scenes with complex geometry or large numbers of objects. Instead of performing culling operations on all objects in the scene at once, layered culling divides the process into multiple layers or stages. Each layer may target specific types of objects, regions of the scene, or visibility criteria. Layered culling often employs a hierarchical structure to organize the scent and prioritize culling operations. This hierarchy may be based on spatial partitioning techniques such as bounding volume hierarchies (BVH), octrees, or grids, which allow for efficient traversal and culling of objects based on their spatial relationships. Within each layer, culling algorithms are applied to determine the visibility of objects relative to the camera or viewers frustrum. Common culling techniques include view frustrum culling, occlusion culling, and level-of-detail (LOD) culling, among others. By organizing culling operations into layers and prioritizing them based on relevance and visibility, layered culling data helps optimize rendering performance by reducing the number of objects that need to be processed and drawn by the graphics hardware. This results in improved frame rates and smoother animation, especially in scenes with large amounts of geometry or complex environments. Operation 414 may include performing verification which comprises verifying data imported into a GPU for compatibility with specifications and expected outcomes.

In some embodiments, the verification of imported data with specifications and expected outcomes may include, for example, verifying compatibility with at least one of: a file format, a coordinate system, a scale unit, an animation frame per second (FPS), meshes number and mesh list, unique names, geometry naming convention, geometry pivots on the origin, vertices ID, continuity, non-manifold Geometry, zero edge length, zero area faces, overlapping/lamina Faces, loose vertex, custom normals, self intersections, mesh intersections, geometry normals continuity between meshes, UV UDIMs, UV Empty Sets, Multiple UV Sets, UV Unused Sets, UV Overlapping, UV Distortion, UV Shell Spacing, UV used area, UV's Out of bounds, skeleton Naming Convention, Bones orientation, Root Bone, Bind Pose(s), Unused Influences, Maximum Influences per vertex, Shading Naming-Convention, Number of Materials, Non ExistingTextures, Texture Resolution, TextureFormat, Color Space, Non-Square Resolution.

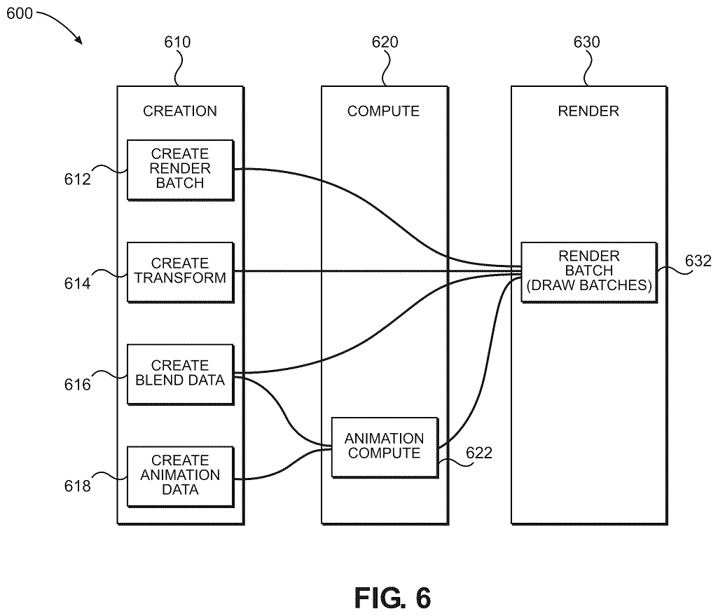

FIG. 6 is a flow diagram 600 of a process for improving the performance of real-time rendering systems via an optimized data set, according to one embodiment. The process comprises three sub-processes that include a creation process 610, a compute process 620 and a render process 640.

### Creation Process 610

The creation sub-process 610 pertains to the creation phase of the data for each frame of the rendering process which involves ensuring that all these elements are properly configured and updated for each frame to render a single frame of an animated sequence, so that the final animation appears smooth, realistic, and visually appealing. This may include calculating transformations, textures, lighting, and any other effects that may change from frame to frame. Data creation may involve several steps, including, but not limited to, modeling, texturing, rigging and animation.

### Create Render Batch 612

The create render batch sub-process 612 comprises from all instances creating all template character draw batches and all attachable draw batches for each character. Where the draw batch refers to graphical elements such as vertices, textures, materials, etc., that can be efficiently rendered together and all instances refers to the multiple instances or variations of the characters or different characters all together. Render batches are typically used to optimize the rendering process, particularly in scenes with a large number of objects or complex visual effects. By organizing elements into batches, rendering software can optimize the rendering process to minimize the number of draw calls made to the graphics hardware. Draw calls involve sending instructions to the GPU to render individual elements and reducing the number of draw calls can improve rendering performance. Moreover, utilizing render batches overcomes the hardware constraints on the number of draw calls it can handle efficiently. By batching elements together, the number of draw calls can be reduced, allowing the hardware to render scenes more quickly and efficiently. In some embodiments, render batches may also be used to control the order in which elements are rendered within a scene. This is important for maintaining the correct visual hierarchy, managing transparency effects, and ensuring the objects occlude others correctly.

### Create Transform Process 614

The create transform sub-process 614 refers to the process of performing transformations for every instance being rendered. In various embodiments, transformations may include, changing an object's position (translation), rotation (an object about one or more axes) and scale (resizing an object along one or more axes) in a virtual 3D space. In some embodiments, the transform process may further include, keyframing, parenting and constraints. Keyframing refers to a technique used to create animation sequences by defining keyframes at specific points in time. Each keyframe specifies the transformation properties of an object at a particular frame, and the animation software interpolates between keyframes to generate smooth motion.

### Create Blend Data Sub-Process 616

The create blend data sub-process 616 refers to a process of generating or setting up data that allows for blending different animation states seamlessly. In an embodiment, each blendshape is placed into an array of indexable blendshapes. In one embodiment, an index/weight array is created per each category of blending, overlaying, culling (i.e., cull masks), overlay textures, skin texture blending and shape blending. This data is shared across all draw calls and is created once.

### Create Animation Data Sub-Process 618

The create animation data sub-process 618 is a process whereby animation data is collected into indexable structures which includes different layers of motion. In this process, animation data is structured and organized efficiently, allowing for easy access and manipulation of different aspects of motion across multiple layers. Animation data refers to information describing how objects or characters move and behave over time in an animated sequence. Animation data can include keyframe positions, rotations, scale, and other attributes that define the motion of objects or characters. The animation data is organized in such a way that allows for efficient indexing or referencing. Indexing structures could include arrays, lists or other data structures that enable quick access to specific elements of the animation data. The indexing includes different layers of motion whereby the layers separate different aspects of motion, such as body movement, facial expressions, or clothing dynamics.

### Compute Process 620

With continued reference to FIG. 6, the compute process refers to a pre-render stage where computations are carried out prior to the actual rendering of a scene. The compute process performs computations or calculations that may involve various calculations related to simulating physics, dynamics, lighting, shading or other aspects of a scene. In an embodiment, the animation compute sub-process 622 computes a set of matrices for every instance in the rendering process. The matrices are computed from the animation data for each blend of the character and blended together to create the animation frame. These matrices together with the bone vertex index/weight will transform each vertex in the mesh. A bone represents a hierarchical node in the skeleton hierarchy. The bones are interconnected to form the skeleton of a character or object, and they control the deformation of the associated mesh during animation.

### Render Process 630

With continued reference to FIG. 6, the render process comprises the point at which the render batch and the collection of draw batches are injected into the render pipeline. More particularly, the render batch sub-process 632 comprises a process whereby the draw batches, which are a collection of Mesh/Material draw calls that use the optimized data. The Mesh/Material draw calls issue instance draw calls to the renderer to complete the composition of the characters represented in the data.

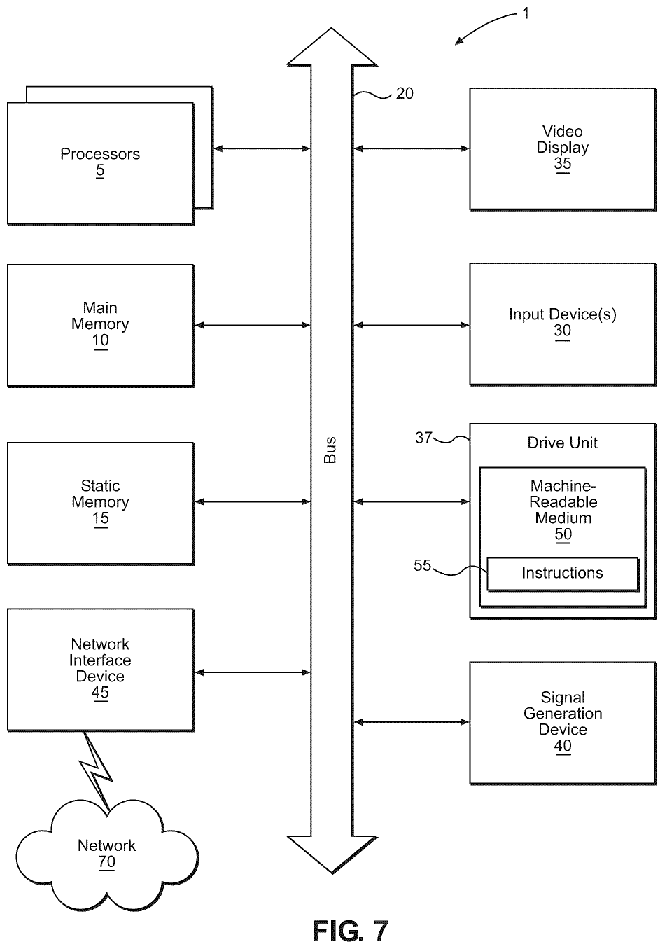

FIG. 7 is a diagrammatic representation of an example machine in the form of a computer system 1, within which a set of instructions for causing the machine to perform any one or more of the methodologies discussed herein may be executed. For example, programming a propagation velocity or pattern to iteratively refine data. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), an embedded computer, a field programmable gate array (FPGA), an application specific integrated circuit (ASIC), a tablet PC, a cellular telephone, a portable media device (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), a network interface device 45, and dielectric measurement hardware 60. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

These computer program instructions may also be stored in a computer readable medium that can direct a computer, other programmable data processing apparatus, or other devices to function in a particular manner, such that the instructions stored in the computer readable medium produce an image, tomograph, or analytic product derived from said image or tomograph, or constituent data thereof including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the present technology to the particular forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A computer implemented method for dynamically improving the performance of real-time rendering systems via the creation and rendering of s based on an optimized data set, the method comprising:
receiving a first input from a user, the first input being in the form of at least one template character comprising a template character shape model and a template character texture model;
optionally, receiving a second input from the user, the second input being in the form of at least one attachable associated with the at least one template character;
receiving a third input from the user, the third input being in the form of at least one base character model comprising a base character shape model and a base character texture model; and
generating, by at least one processor, the optimized data set comprising:
optionally, fitting the at least one attachable associated with the at least one template character to the at least one base character model;
converting the at least one base character shape model and the at least one base character texture model to an optimized data set; and
generating runtime variations on the optimized data set.

2. The computer implemented method of claim 1, further comprising compositing and rendering the generated runtime variations, wherein the runtime variations are generated by character blending at least two template character shape models with the at least one template character texture model.

3. The computer implemented method of claim 1, further comprising compositing and rendering the generated runtime variations, wherein the runtime variations are generated by character blending at least two base character shape models with the at least one base character texture model.

4. The computer implemented method of claim 1, further comprising compositing and rendering the generated runtime variations, wherein the runtime variations are generated by character blending the at least one template character shape model with the at least one base character shape model and with one of the at least one base character texture model or the at least one template character texture model.

5. The computer implemented method of claim 1, further comprising compositing and rendering the generated runtime variations, wherein the runtime variations are generated by stylizing at least two template character shape models with the at least one template character texture model.

6. The computer implemented method of claim 1, further comprising compositing and rendering the generated runtime variations, wherein the runtime variations are generated by stylizing at least two base character shape models with the at least one base character texture model.

7. The computer implemented method of claim 1, further comprising compositing and rendering the generated runtime variations, wherein the runtime variations are generated by stylizing the at least one template character shape model with the at least one base character shape model and with one of the at least one base character texture model or the at least one template character texture model.

8. The computer implemented method of claim 1, wherein the runtime variations are generated by at least one of: creating character groups, constraining the facial body shape models and/or texture models, constraining the usage of attachables, constraining the colorization of 3D assets.

9. The computer implemented method of claim 1, wherein the at least one attachable is associated with a 3D character other than the template character.

10. The computer implemented method of claim 9, wherein the step of generating the optimized data set further comprises, prior to the converting step:
asset fitting the at least one attachable associated with the 3D character to the template character to yield a template-fitted attachable; and
asset fitting the template-fitted attachable to the at least one base character.

11. A computer implemented method for dynamically improving the performance of real-time rendering systems via the creation and rendering of s based on an optimized data set, the method comprising:
receiving a first input from a user, the first input being in the form of at least one template character comprising a template character shape model and a template character texture model, and a template animation rig;
optionally, receiving a second input from the user, the second input being in the form of at least one attachable associated with the at least one template character;
receiving a third input from the user, the third input being in the form of at least one base character model comprising a base character shape model and a base character texture model;
receiving a fourth input from the user, the fourth input being in the form of at least one animation clip;
generating, by at least one processor, an optimized data set comprising:
optionally, fitting the at least one attachable associated with the at least one template character to the at least one base character model;
retargeting the template animation rig to the at least one base character model;
retargeting the template animation rig to the at least one attachable, in the case where the at least one attachable is received as the second input;
converting the at least one base character shape model and the at least one base character texture model to optimized data set; and
generating runtime variations on the optimized data set.

12. The computer implemented method of claim 11, further comprising compositing and rendering the generated runtime variations, wherein the runtime variations are generated by character blending at least two template character shape models with the at least one template character texture model.

13. The computer implemented method of claim 11, further comprising compositing and rendering the generated runtime variations, wherein the runtime variations are generated by character blending at least two base character shape models with the at least one base character texture model.

14. The computer implemented method of claim 11, further comprising compositing and rendering the generated runtime variations, wherein the runtime variations are generated by character blending the at least one template character shape model with the at least one base character texture model.

15. The computer implemented method of claim 11, further comprising compositing and rendering the generated runtime variations, wherein the runtime variations are generated by stylizing at least two template character shape models with the at least one template character texture model.

16. The computer implemented method of claim 11, further comprising compositing and rendering the generated runtime variations, wherein the runtime variations are generated by stylizing at least two base character shape models with the at least one base character texture model.

17. The computer implemented method of claim 11, wherein the runtime variations are generated by at least one of: creating character groups, constraining the facial body shape models and/or texture models, constraining the usage of attachables, constraining the colorization of 3D assets.

18. The computer implemented method of claim 11, wherein the at least one attachable is associated with a 3D character other than the template character.

19. The computer implemented method of claim 11, wherein the step of generating the optimized data set further comprises, prior to the converting step:
asset fitting the at least one attachable associated with the 3D character to the template character to yield a template-fitted attachable; and
asset fitting the template-fitted attachable to the at least one base character.

20. A system for improving the performance of real-time rendering systems via the creation and rendering of s based on an optimized data set, the method comprising:
a processor; and
a memory for storing executable instructions, the processor executing the instructions to:
receive a first input from a user, the first input being in the form of at least one template character comprising a template character shape model and a template character texture model;
optionally, receive a second input from the user, the second input being in the form of at least one attachable associated with the at least one template character;
receive a third input from the user, the third input being in the form of at least one base character model comprising a base character shape model and a base character texture model; and
generate, by at least one processor, the optimized data set comprising:
optionally, fit the at least one attachable associated with the at least one template character to the at least one base character model;
convert the at least one base character shape model and the at least one base character texture model to an optimized data set; and
generate runtime variations on the optimized data set.
